(19) United States
(12) Patent Application Publication
(10) Pub. No.: US 2005/0283647 A1
(43) Pub. Date: Dec. 22, 2005

(54) External storage device

(75) Inventors: Takashi Ishidoshiro, Nagoya-shi (JP); Yoshiiku Sonobe, Nagoya-shi (JP)

Correspondence Address: BEYER WEAVER & THOMAS LLP, P.O. BOX 70250, OAKLAND, CA, 94612-0250, US

(73) Assignee: BUFFALO INC.

(21) Appl. No.: 11/031,540

(22) Filed: Jan. 7, 2005

(30) Foreign Application Priority Data
Jan. 9, 2004 (JP) 2004-4370

(51) Int. Cl. G06F 11/00

(52) U.S. Cl. 714/5

(57) ABSTRACT

This is an external storage device for which erase is performed as units of blocks comprising a plurality of pages, and that uses flash memory that uses this page as the minimum unit for reading and writing data, the flash memory comprising a redundant part area for storing codes for performing error correction of specified bit counts for each of the pages, and a bit substitute area at specified areas within the flash memory. The external storage device includes a bit management unit existed within the page and that is for allocating the address of the bit substitute area to the defective bits that are beyond scope of the page unit error correction, and a block control unit that replaces the defective bit with the bit within the bit substitution area and performs reading and writing of the data to the block containing the defective bits. With this external storage device, it is possible to improve the use efficiency of the flash memory.

### CLAIM OF PRIORITY

The present application claims priority from Japanese application P2004-4370 filed on Jan. 9, 2004, the content of which is hereby incorporated by reference into this application.

### BACKGROUND OF THE INVENTION

1. Field of the Invention

The present invention relates to an external storage device which incorporates flash memory.

2. Description of the Related Art

From the past, there have been external memory devices which incorporate flash memory which is non-volatile semiconductor memory. Flash memory consists of a plurality of blocks for storing data, and for construction, data erase is performed in block units, with a limit on the erase count per one block. With the external storage device which incorporates flash memory, for managing information for each of this kind of block, for example with the erase count as the judgment criterion for whether or not a block can be used, blocks that have exceeded that criterion are not used, and this is handled by writing data to a substitute block.

For example, in the Japanese Patent No. 3226042, disclosed is a substitution process technology whereby, when the occurrence count of defective cells detected within a sector (block) exceeds a specified scope, data is replaced in a redundant sector that is a substitute for the defective sector. The block that contains this kind of defective cell is replaced by a substitute block that was prepared in advance, and management is done on the system side. In other words, the system executes smooth data saving by saving to the substitute block the data for which an attempt is being made to save to a block that is managed as being unusable.

The defect that occurs with the flash memory of this kind of system is not limited to items at this stage of use, but also, for example, exists in items that occur with the manufacturing process. Normally, the flash memory manufacturer does shipping while storing in one area of the flash memory the information for indicating that this is a block for which a defect occurred at the manufacturing shipping stage (defective block). With this kind of system for incorporating the flash memory for which block management information is stored, the system is constituted such that the system side recognizes the block good/bad information before use, and for blocks regarded as defective blocks, thereafter, this is not accessed.

However, with the handling of this kind of defective block, there was the problem that the use efficiency as the overall flash memory worsened. Within the defective blocks, there are cases when only part of the bits within the block are damaged. For example, even in a case when there are a few bits of damaged bits in a certain block, that entire block was handled as being unusable.

### SUMMARY

The purpose of the present invention is to provide an external storage device that solves at least part of this kind of problem and that improves memory use efficiency.

The external storage device of the present invention uses the following structure to solve at least part of the problems noted above. Specifically, this is an external storage device for which erase is performed in units of blocks formed from a plurality of pages, and that uses flash memory having the page as the minimum unit for data reading and writing, the flash memory is configured with a storage area to be read and wrote data at a page as a minimum access unit and to be erased at a block as a minimum erase unit, a redundant area to be provided within each of the pages and stored codes for performing error correction of at least one bit, and a bit substitute area reserved in advance for replacement. The external storage device] includes a bit management unit that allocates a replacement address in the bit substitution area to defective bits that are existed within the page and beyond scope of the error correction, and a block control unit that performs reading and writing of the data to the block containing the defective bits, that are beyond scope of the error correction, with replacement of the defective bits with the bits in the bit substitution area according to the replacement address.

According to the external storage device of the present invention, with the error correction using the codes stored in the redundant part area, bit unit substitution is performed on the defective bits for which correction is not possible, and defective bits for which error correction is possible are used as is. Therefore, it is possible to effectively use the blocks containing the defective bits, and it is possible to construct a system for which flash memory can be used efficiently.

For the external storage device having the constitution noted above, it is also possible to have the bit substitution area provided at a specified page for each of the blocks, and to allocate the address of a bit within the bit substitution area that exists within the same block to the defective bit that are beyond scope of the error correction.

According to the concerned external storage area, the defective bits that exist within one block are substituted using block units, and that substitution area is provided within the same block. Therefore, with access to one block, it is possible to perform reading and writing of data continuously.

The bit management unit of the external storage device having the constitution noted above may also comprise a address storage area for storing the address necessary for the bitwise replacement at the specified location of the flash memory. According to the concerned external storage device, the information necessary for the bit unit substitution is stored in the specified location within the flash memory. Therefore, it is not necessary to provide individual memory for storing the information. Also, because this is flash memory, it is possible to do non-volatile storage of the information. Specifically, by storing within the same block information such as the bit substitution area and the address for the defective bits within one block, it is possible to make processing easy.

The flash memory of the external storage device having the constitution noted above may also be NAND type structure flash memory. Generally, with the NAND type structure flash memory for which high integration is possible, because of manufacturing that shares the bit line contact, it is possible for one defect to occur across a broad scope. By using the present invention for this kind of NAND type structure flash memory, it is possible to especially improve the use efficiency.

### BRIEF DESCRIPTION OF THE DRAWINGS

FIG. 1 is an overall block diagram showing the constitution of the external storage device as the first embodiment of the present invention.

FIG. 2 shows the constitution of the flash memory used with this embodiment.

FIG. 3 is a flow chart of the bit unit substitution process of this embodiment.

FIG. 4A and FIG. 4B are explanatory drawings showing the state before and after the bit unit substitution process.

### DESCRIPTION OF THE PREFERRED EMBODIMENTS

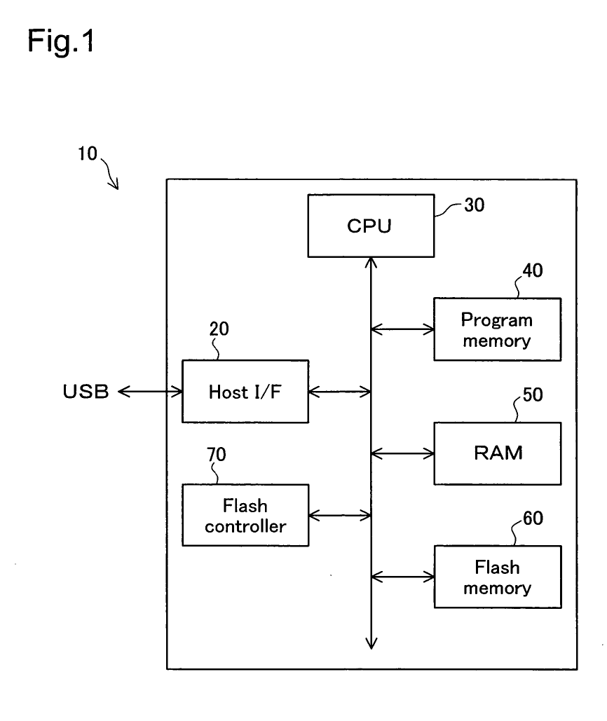

Following, an embodiment of the external storage device of the present invention is described. FIG. 1 is an overall block diagram showing the constitution of the external storage device 10 as an embodiment of the present invention. As shown in the drawing, this external storage device 10 comprises a host I/F 20 for exchanging data with external devices, a CPU 30, a program memory 40, a RAM 50, a flash memory 60 for doing non-volatile saving of data from outside, a flash controller 70 for controlling reading and writing of data to the flash memory 60, and the like.

The host I/F 20 complies with the Universal Serial Bus (USB) standard, and connection with external devices (e.g. a personal computer, digital still camera, or the like) is possible. Access such as writing and reading of data from the external device to the external storage device 10 is performed via this host I/F 20. Note that the host I/F 20 is not limited to USB, but may also comply with a standard such as the IEEE 1394, ATA, or the like.

The CPU 30 reads the execution program from the program memory 40 when the power is turned on, and prepares an operation area for the overall external storage device 10. The CPU 30, for example, when a data rewrite request is received from the external device via the host I/F 20, reads the data within the flash memory 60 temporarily with the RAM 50 as the work area, performs data correction, and again writes the data to the flash memory 60. In specific terms, the CPU 30 outputs to the flash controller 70 instructions to read the data within the flash memory 60, instructions to write corrected data, and the like.

According to the instructions of the CPU 30, the flash controller 70 does management and control within the flash memory 60 such as reading of data from the flash memory 60, writing of data, erasing of data, and the like. In specific terms, to avoid frequent rewriting of data to a particular area that reduces the life of the flash memory 60, the areas for which data write is possible are calculated, and control is performed to average the use of the data write areas of the flash memory 60.

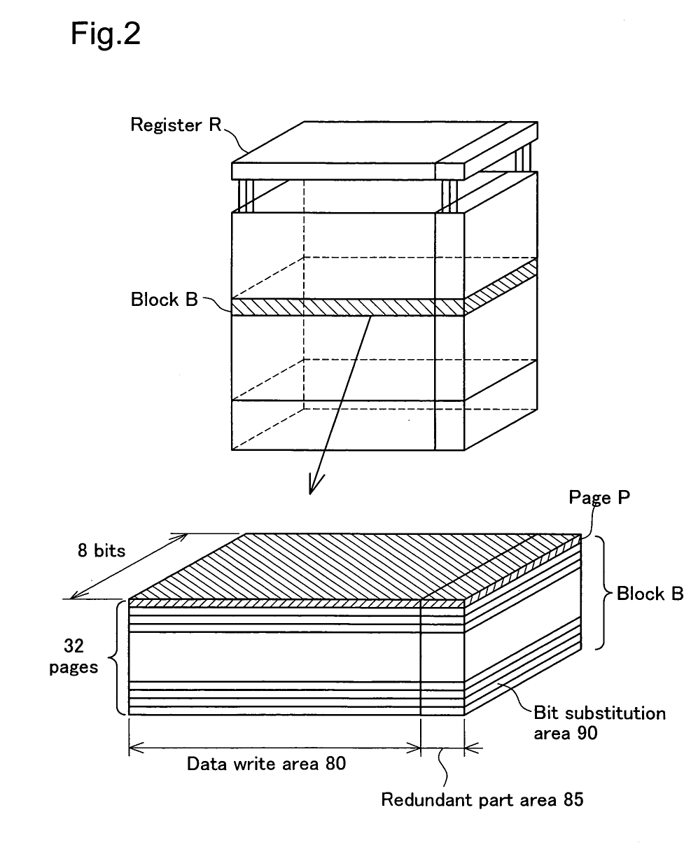

The flash memory 60 is memory that comprises a plurality of blocks that are areas for writing data, and that stores data in each of the blocks. FIG. 2 shows the structure of the flash memory 60 used with this embodiment. With this embodiment, NAND type flash memory having a capacity of 256 Mbits is used. As shown in the drawing, this flash memory 60 comprises a register R for receiving instructions from the flash controller 70 and for temporarily storing data, and a plurality of physical blocks B that are data storage areas. This one block B is divided into 32 page areas.

This flash memory 60 performs data erase in block units, and reads and writes data in page units. The one page that is the minimum unit for reading and writing comprises a data write area 80 of a specified capacity and a redundant part area 85 for storing management information such as the error correction code (ECC code) or the block use status. Also, the page before the last page (page 31) is used as the bit substitution area 90 that is the defective bit substitution area described later. This bit substitution area 90 may also be provided on any page within the same block.

The ECC (Error Correcting Code) code is a redundant code added separately from the original data for correcting errors such as bit garbling and the like. The flash controller 70 generates the ECC code for the data written to the specified block B. In other words, the flash controller 70 adds the ECC code to the data at the data write stage, and stores it in the flash memory 60.

The ECC code generated in this way is used, for example, in cases when there is a command to the external storage device 10 from the personal computer which is the external device to read specified data. The CPU 30 that receives the read command via the host I/F 20 sends an output command for the requested data to the flash controller 70. The flash controller 70 that receives the command reads the requested data from the concerned block together with the ECC code, and performs a data error check based on the ECC code. As a result of the error check, when there are no errors, data is sent to the personal computer as is. On the other hand, when there is an error within the correctable range, the bits of the concerned location are inverted, and the corrected, appropriate data is output to the personal computer.

Note that with the ECC function of this embodiment, 2-bit error correction per page P is possible. This 2-bit error correction can be realized using the Reed-Solomon code.

The bit substitution area 90 is an area for substituting the data written to the defective bit in another area within the same block in cases when, for the defective block that contains some kind of defect in advance at the time of manufacturing and shipping, a defect check is performed in bit units, and defective bits of a specified quantity are detected. The flash memory 60 of this embodiment does a close inspection of the defective blocks, and when there are defective bits greater than a specified count, the bit unit substitution process is executed, and the usable memory area is expanded.

Note that the information needed for this bit unit substitution, such as the bit address for substitution and the page number for executing the bit unit substitution and the like is stored in the final page for each block. This information may also be provided within the same page as the bit substitution area 90.

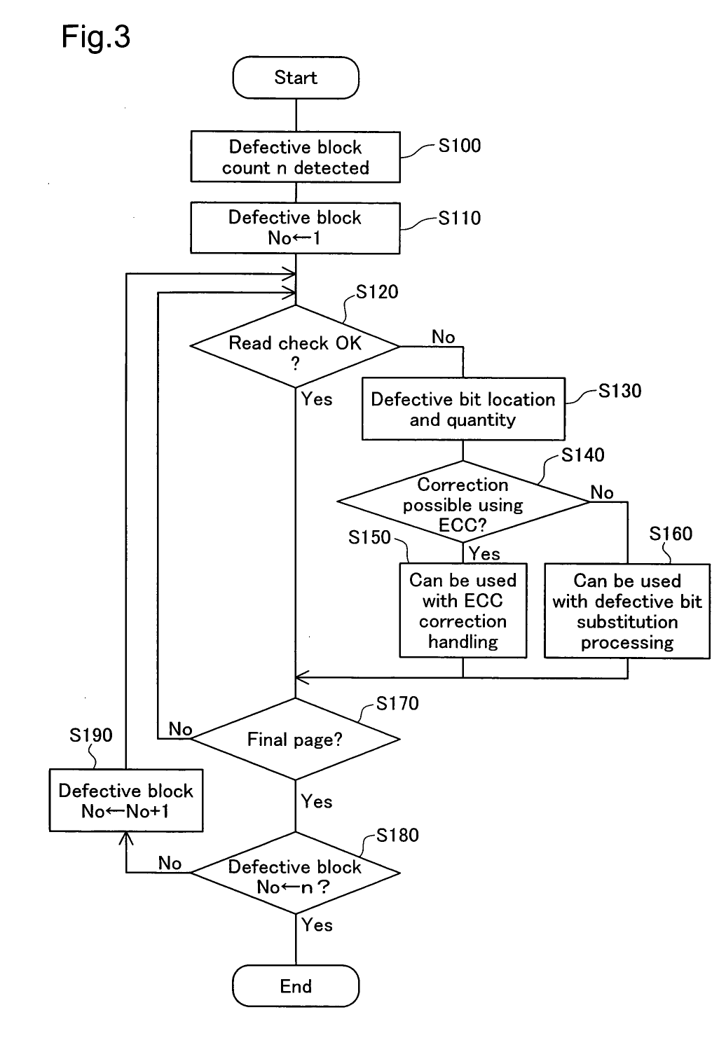

The bit unit substitution process for this defective block will be described. FIG. 3 is a flow chart showing the defective block use possibility determination and the bit unit substitution process. This process is executed by the external device at the manufacturing stage of the external storage device 10.

First, for all the blocks of the flash memory 60, the external device performs a determination of whether or not the block is considered to be a defective block at the manufacturing and shipping stage, and the defective block count n is detected (step S100). The flash memory 60 of this embodiment inputs in advance the data indicating the block use possibility at the 517th byte at the starting page of each block. By reading this data, a determination is made of whether or not each block is a defective block.

The external device performs detection of defective blocks in sequence from the first block in the physical constitution sequence of the blocks, specifies the defective block that is first detected as the first defective block (No 1), and performs detection of defective blocks sequentially to the final block. At this step, the correlation between the defective block total count n and each defective block number and each physical block number is detected.

Then, the physical block corresponding to the first defective block specified at step S100 is selected (step S110), and a read check is performed on this block (step S120). With this read check, by writing specified data to each page of the first defective block, and comparing the written data and the read data, the presence or absence of a bit unit error is detected. For example, as specified data, “101010 . . . ” check data is written to the first page of the first defective block, this is read, and both of these are compared. This check data reading and writing is performed twice so that the value “0” and the value “1” data are written corresponding to one address. Note that for the data reading, with one time specification of the start address, the bus mode for which continuous read execution is possible is used.

At step S120, when the read data is the same as the check data, “no error” is determined, and a determination is made of whether the read checked page is the final page (step S170). At step S170, when it is determined that read check is not performed to the final page, the process returns to step S120, and the read check is performed on the next page. Meanwhile, when it is determined that the read check was performed on the final page, in other words, when it is determined that the read check was executed for all the pages of the first defective block, the process moves to the process of determining whether or not the defective block for which read checking was performed is the final block (step S180).

At step S180, when the read checked defective block is the last (nth) one, and when it is determined that there are no other defective blocks that have not been checked, this processing ends. Meanwhile, at step S180, when it is determined that the read checked defective block is not the final one, at No=No +1 (step S190), the process returns to step S120, and a read check is performed on the next defective block.

At step S120, when the read data is different from the check data, this is determined to be “there is an error,” and the defective bit location (address) and quantity are specified (step S130). For example, when the preceding check data is used, if the read data is “100010 . . . ”, it is determined that a 1-bit error has occurred at the third bit (1 page).

Next, a determination is made of whether or not the number of detected defective bits is within the correctable bit count scope of the ECC function (step S140). With this embodiment, up to 2 bits of error correction is possible, and the standard is whether the detected bit error is 1 bit or less. This is because even if bit error occurs later due to use of the flash memory 60, if it is an error up to 1 bit, it is possible to handle with the ECC function.

At step S140, when it is determined that the defective bits are 1 bit or less, the page that contains that defective bit is recognized as a usable page (step S150), and a determination is made of whether the read check has been executed up to the final page (step S170). When it is not the final page, at the next page, the processing from step S120 is repeated, and when it is the final page, the process from step 180 and thereafter is repeated.

Meanwhile, at step S140, when it is determined that the detected bit error is greater than 1 bit, it is not possible to handle this with the ECC function correction, and the defective bit substitution process for replacing the defective bits with the bit substitution area 90 is performed (step S160). In specific terms, the bit address (substitution address) within the bit substitution area 90 provided within the same block is allocated to the defective bit, a correspondence table of the defective bit location page number and address and the bit substitution area 90 substitution address is generated, and the process of writing this table to the last page of the flash memory 60 is performed.

By storing the defective bit substitution address and the like at step S160, it is determined that the page on which the defective bit exists with the read check is usable, and a determination is made whether the read check is executed to the final page (step S170). When it is not the final page, at the next page, the process from step S120 is repeated, and when it is the final page, the process from step S180 and thereafter is repeated. At step S180, when the read checked defective block is not the final block, at the next defective block, the process from step S120 is repeated, and when it is the final block, this series of processes ends.

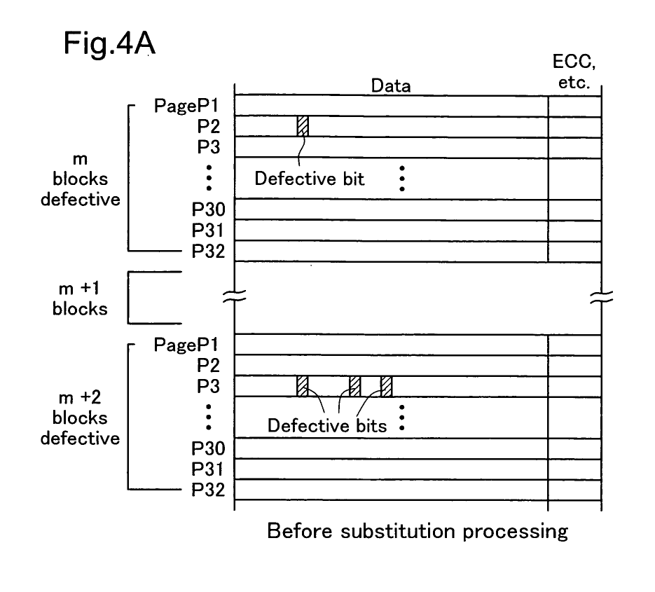

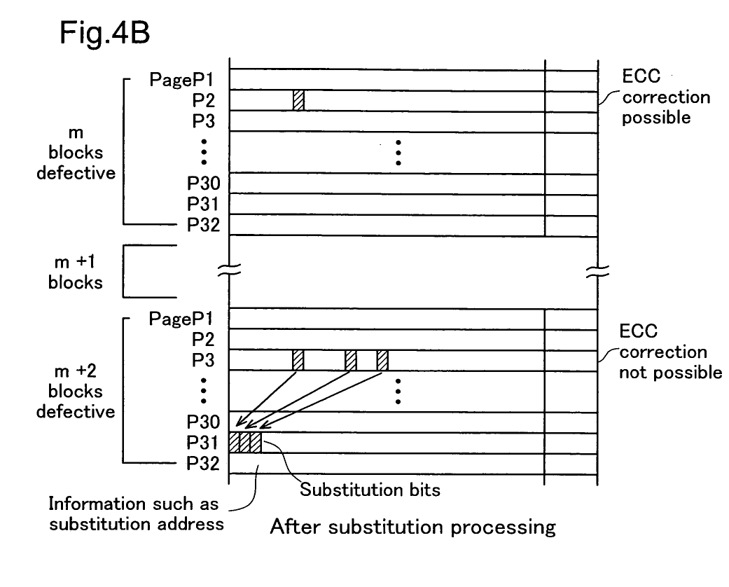

Through this process, the blocks recognized as defective blocks at the manufacturing and shipping stage are recognized as usable blocks. FIG. 4A and FIG. 4B are explanatory drawings showing the status of the blocks before and after the execution of the bit unit substitution process. FIG. 4A shows an example of the external storage device manufactured by incorporating the flash memory for which the defective block is managed as is at the manufacturing and shipping stage. As shown in the drawing, the second page of the mth block contains the 1-bit defective bit, and the mth block is defined as unusable. Similarly, the m +2 block contains a 3-bit defective bit in the 3rd page and is also judged as unusable.

Meanwhile, FIG. 4B shows an example of the external storage device 10 manufactured incorporating the flash memory 60 for which the bit unit substitution process is executed. As shown in the drawing, the defective bit of the second page of the mth block is error correctable using the ECC function, so is a block that can be used as is. The m +2 block contains a 3-bit defective bit in the 3rd page, so this page cannot be handled using error correction. Because of this, the defective bit substitution bit is allocated to the 31st page. In this way, the data to be written to the defective bit of the 3rd page is written to the substitute bits, and this block also becomes a usable block. Note that the information such as the substitution address and the like used for the bit unit substitution is written to the last page.

The management information for blocks recognized as usable is written to the redundant part area 85 of the flash memory 60 with the manufacturing process of the external storage device 10. In other words, instead of the information indicating the defective block at the manufacturing and shipping stage of the flash memory, or separate from that, all the block management information is generated, and written to the redundant part area 85. With the external storage device 10 that incorporates this flash memory 60, the flash controller 70 recognizes the bit unit substitution address, and when writing data to the m +2 block, the substitution address is read, and the data written to the defective bit address is written to the substitution address, and when reading, the process of reading the data from the substitution address is performed. Also, when writing the data to the mth block, the data is written as is, and when reading, suitable data is output by executing correction using the ECC function.

With this series of processes, a close inspection is done of the defective locations of the blocks determined to be defective at the manufacturing and shipping stage, and if this is a bit error that is within the ECC function correctable range, it is a block that is usable as is, and if it is a bit error that is outside the correctable range, a substitution bit is allocated to make it a usable block. Therefore, it is possible to efficiently use the effective bit area within the defective block. Furthermore, it is possible to provide the substitution area within the same block because bit unit substitution is performed. Therefore, compared to when executing substitution using block units, it is possible to generate successive recording areas and to build an efficient system.

Note that, with this embodiment, a limit is not provided on the quantity of substitute defective bits, but when defective bits greater than a specified number are detected, it is possible to consider the block as having low reliability, with that block as a defective block, and thereafter to prohibit access. Also, with this embodiment, performance of a check to determine usability is performed only on defective blocks, but it is also possible to perform a check on all the blocks of the flash memory 60. In this case, it is possible to accurately understand the defects that occurred with the distribution process.

Also, with this embodiment, bit unit substitution was used for the 2-bit defective bits, but it is also possible, for example, to, among 2-bit defective bits, substitute 1 bit, and to correct the remaining 1 bit using the ECC function and consider that a usable block.

Note that with this series of processes, the external storage device for which the usable blocks of the flash memory 60 were expanded was generated, but it is also possible to give this process execution function to the flash controller 70. In this case, at a specified timing such as when the power is turned on or the like, it is possible to execute the read check on the block that is an empty space, and to recognize that as a usable block.

Above, embodiments of the present invention were described, but the present invention is not limited in any way to this kind of embodiment, and it is of course possible to obtain various embodiments within a scope that does not stray from the key points of the present invention. With this embodiment, the constitution was such that 2-bit correction is possible as the ECC function, but it is also possible to further strengthen the ECC function so that correction is possible for a plurality of bits. In that case, the constitution is such that the redundant part area is increased, and the ECC code is stored.

1. An external storage device comprising:
flash memory that is configured with a storage area to be read and wrote data at a page as a minimum access unit and to be erased at a block as a minimum erase unit, a redundant area to be provided within each of the pages and stored codes for performing error correction of at least one bit, and a bit substitute area reserved in advance for replacement;
a bit management unit that allocates a replacement address in the bit substitution area to defective bits that are existed within the page and beyond scope of the error correction; and
a block control unit that performs reading and writing of the data to the block containing the defective bits, that are beyond scope of the error correction, with replacement of the defective bits with the bits in the bit substitution area according to the replacement address.

2. The external storage device in accordance with claim 1, wherein
the bit substitution area is provided in a specified page for each of the blocks, and;
the bit management unit allocates the address of the bit within the bit substitution area provided in the same block to the defective bits that are beyond scope of the error correction.

3. The external storage device in accordance with claim 1, wherein
the bit management unit comprises a address storage area for storing the address used for the bitwise replacement at a specified location of the flash memory.

4. The external storage device in accordance with claim 2, wherein
the bit management unit comprises a address storage area for storing the address used for the bitwise replacement at a specified location of the flash memory.

5. The external storage device in accordance with claim 1, wherein the flash memory has a NAND type structure.
